(19) United States
(12) Patent Application Publication
(10) Pub. No.: US 2019/0203474 A1
(43) Pub. Date: Jul. 4, 2019

(54) LIGHT CONVEYING SKYLIGHT DIFFUSER FRAME

(71) Applicant: VKR HOLDING A/S, Horsholm (DK)

(72) Inventor: Brian Jefferson Burkes, Greenwood, SC (US)

(21) Appl. No.: 16/239,682

(22) Filed: Jan. 4, 2019

Related U.S. Application Data
(60) Provisional application No. 62/709,063, filed on Jan. 4, 2018.

(51) Int. Cl. E04D 13/03; G02B 5/02

(52) U.S. Cl. CPC E04D 13/033; E04D 2013/0345; G02B 5/0278

(57) ABSTRACT

A skylight comprising a frame that includes a light conductive path having a first end proximate to a light shaft and a second end distal to the light shaft. The frame may reside at the interior termination of the skylight light shaft. The light path may extend to the perimeter of the frame. A diffuser lens may also be provided, and the frame may be integral with the diffuser lens.

### CROSS REFERENCE TO RELATED APPLICATIONS

This application claims the benefit of priority of U.S. Provisional Application Ser. No. 62/709,063, filed on Jan. 4, 2018, which is incorporated herein in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIALS SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR A JOINT INVENTOR

Not applicable.

### BACKGROUND OF THE INVENTION

### Field of the Invention

The current invention relates to a diffuser element for skylights. More specifically, the current invention relates to a skylight diffuser frame that itself conveys light.

### Description of the Related Art

Skylights provide natural light to the interior of a building by capturing daylight at an exterior roof-mounted cover and conveying that light into a building interior through an interior diffuser element.

The diffuser element is typically mounted at the interior end of the light shaft, upon a building interior ceiling, and includes a lens and a decorative frame. The diffuser lens may be transparent, but more often is translucent. The diffuser lens achieves at least three purposes: (1) it scatters the light entering the room through the skylight into a more aesthetically pleasing array; (2) it conceals the internal structural details of the skylight from normal viewing angles within the building interior; and (3) it provides an attractive interior termination to the skylight. The diffuser frame may conceal irregularities in the ceiling opening that was created to allow passage of the skylight, and it may also provide an ornamental border around the diffuser lens.

Examples of skylight diffusers and diffuser frames are disclosed in the present assignee's U.S. Pat. Nos. 9,702,149 and D793,579, the disclosures of both of which are incorporated herein by reference.

Considering the diffuser frame's proximity to the light within the skylight and the diffuser frame's contribution toward providing an appealing visual element to the skylight system, it would be advantageous if a diffuser frame could further utilize that light to enhance the attractiveness and functionality of the skylight system.

### BRIEF SUMMARY OF THE INVENTION

The present invention discovers an elegant additional utilization of the light within a skylight to further increase the attractiveness of the skylight system to occupants of the building interior, by conveying some of that light by the use of the diffuser frame. The present invention offers an improvement upon the known systems for skylight diffuser frames and provides distinct advantages over the conventional systems.

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

As used herein, the terms “comprising,” “include,” “includes,” and “including” may be taken to specify the presence of stated features or components but does not preclude the presence or addition of one or more other features or components, or groups thereof.

In accordance with certain aspects of certain embodiments of the present technology, a skylight is provided that includes a light shaft and a diffuser frame, the diffuser frame including a light path. The light shaft may have a third end and an opposite fourth end, and the frame may reside at the fourth end. The light path has a first end and an opposite second end, the first end disposed proximate to the light shaft and the second end disposed distal to the light shaft. The light path is light conductive from the light shaft to the second end. The frame may define a perimeter and the second end may be disposed at the perimeter. In some embodiments, the frame may define the light path. A diffuser lens may also be included, and in certain applications the diffuser lens may be integral with the frame.

In accordance with certain aspects of other embodiments of the present technology, a skylight is provided that includes a light shaft and a frame, the frame having an outer perimeter disposed away from the light shaft. The skylight may further include a diffuser lens, wherein the diffuser lens is carried by the frame. In some situations, the diffuser lens may be integral with the frame. The diffuser lens may at least partially reside in a first plane, and the frame may reside at least partially in a second plane, the first plane being parallel to the second plane. The light shaft may have a first end and a second end, and the frame may be disposed at the second end. A light path is also provided, the light path extending from the light shaft toward the frame's outer perimeter and being light transmissive. In particular embodiments, the light path may extend to the outer perimeter of the frame. In particular embodiments, the light path may extend to the frame's outer perimeter and may be exposed free of opacity about the perimeter of the frame.

In accordance with certain aspects of still other embodiments of the present technology, a skylight is provided that includes a light shaft, the light shaft having a first end and an opposite second end. The skylight also includes an interior diffuser lens, the interior diffuser lens residing at the second end. A frame is further included, the frame surrounding the interior diffuser lens. In some embodiments, the frame may be integral with the interior diffuser lens. The frame may define a perimeter distal to the light shaft, and may be light transmissive from the light shaft to the perimeter. The diffuser lens may reside at least partially in a first plane and the frame may reside at least partially in a second plane, the first plane being parallel to the second plane. In other configurations, the diffuser lens may reside at least partially in a third plane and the frame may reside at least partially in the third plane. The frame may be exposed about the entirety of its perimeter. The skylight may include a mount, the mount being connected to the light shaft and connected to the frame. In selective applications, the frame may be annular.

Additional objects and advantages of the present subject matter are set forth in, or will be apparent to those of ordinary skill in the art from, the detailed description herein. Also, it should be further appreciated that modifications and variations to the specifically illustrated, referred, and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, directed to one of ordinary skill in the art, is set forth in the specification, which makes reference to the appended figures, in which:

FIG. 1 is a elevation view of a skylight, installed in a building, according to an embodiment of the present invention;

FIG. 2 is a perspective view of a diffuser lens and diffuser frame according to an embodiment of the present invention;

FIG. 3 is a sectional view, taken at A:A in FIG. 1, of skylight components according to an embodiment of the present invention;

FIG. 4 is a sectional view, taken at A:A in FIG. 1, of skylight components according to an embodiment of the present invention;

FIG. 5 is a broken perspective sectional view, taken at A:A in FIG. 1, of skylight components according to an embodiment of the present invention; and

FIG. 6 is a broken perspective sectional view, taken at A:A in FIG. 1, of skylight components according to an embodiment of the present invention.

It should be noted that the drawings discussed above and below are not to scale in all instances, but may have exaggerated dimensions in some respects to illustrate principles of the invention.

### DETAILED DESCRIPTION OF THE INVENTION

Reference will now be made in detail to the embodiments of the present invention, one or more examples of which are illustrated in the drawings. Each example is provided by way of explanation of the invention, and is not meant as a limitation of the invention. For example, features illustrated or described as part of one embodiment may be used with another embodiment to yield a still further embodiment. It is intended that the present application include such modifications and variations as come within the scope and spirit of the invention.

Repeat use of reference characters throughout the present specification and appended drawings is intended to represent same or analogous features, elements, or components of the invention.

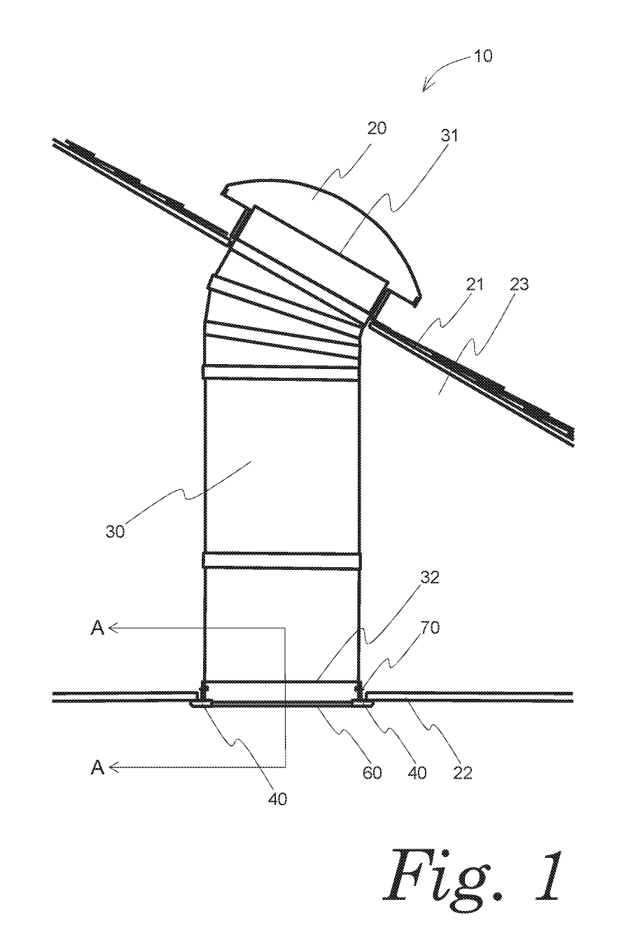

FIG. 1 illustrates an embodiment of a skylight, generally designated 10, according to the present invention and installed in a building. Skylight 10 includes a cover 20, a light shaft 30, a diffuser lens 60, and a diffuser frame 40. The skylight 10 is illustrated as installed through a building roof 21 and through a building interior ceiling 22. Roof 21 is illustrated in FIG. 1 as inclined, but flat roofs 21 are encountered as well, and the skylight 10 performs equally well with either roof configuration. Between roof 21 and ceiling 22 may reside an attic 23 in some applications, and skylight 10 is illustrated to traverse attic 23 by light shaft 30. In other applications, no attic 23 may be encountered, and light shaft 30 may instead reside between cover 20 and ceiling 22 such as, for example, across the dimension of roof rafters or roof trusses (not shown). In general, light shaft 30 may be understood to be that portion of a skylight 10 that resides between a cover 20 and a diffuser lens 60. Light shaft 30 transports light from cover 20 to diffuser lens 60.

The cover 20 resides on skylight 10 on the exterior of roof 21. Cover 20 as illustrated in FIG. 1 is a dome, but flat covers 20 may be used with the present invention as well. Cover 20 receives exterior light, such as sunlight, and conveys that light into light shaft 30.

Light shaft 30 may be constructed of plaster board, other wallboard, or similar material. Alternatively, light shaft 30 may be made of metal, plastic, and/or other materials. Light shaft 30 may be tubular in some applications.

Light shaft 30 may be understood to have one end, denominated herein as third end 31, located proximate to cover 20 and another end, denominated herein as fourth end 32, located proximate to ceiling 22 and to diffuser lens 60.

Diffuser lens 60 resides at fourth end 32 of skylight 10. Diffuser lens 60 is illustrated in FIG. 1 as planar, and as parallel with the plane of ceiling 22, but other configurations may be used in particular applications without departing from the present invention. Diffuser lens 60 may be transparent or translucent, and diffuser lens 60 conveys light received from light shaft 30 into the interior of the building. Diffuser lens 60 scatters the light received from light shaft 30 into an interior room, conceals internal structural details of skylight 10 from normal viewing angles within the building interior, and provides an attractive interior termination to skylight 10.

Diffuser lens 60 may be carried by, or alternatively may carry, a frame 40. Frame 40 may conceal irregularities in the opening to ceiling 22 that was created to allow passage of the skylight 10, and may also provide an orderly and ornamental border at the diffuser lens 60.

Depending upon user preference, the perimeter of frame 40 may be round, rectangular, or of other shape. For example, if the perimeter of diffuser lens 60 is round, the perimeter of frame 40 may also, but need not necessarily, have a matching round outside perimeter 41. In other applications, depending on user preference or upon other considerations, though the perimeter of diffuser lens 60 be round, the perimeter 41 of frame 40 may be rectangular. Alternatively, in still other applications, depending on user preference or other considerations, though the perimeter of diffuser lens 60 be polygonal, the perimeter 41 of frame 40 may be curvilinear, or vice versa. Similarly, in some applications frame 40 may surround diffuser lens 60; in other applications, frame 40 may only be adjacent to diffuser lens 60 at less than the entirety of the perimeter of diffuser lens 60.

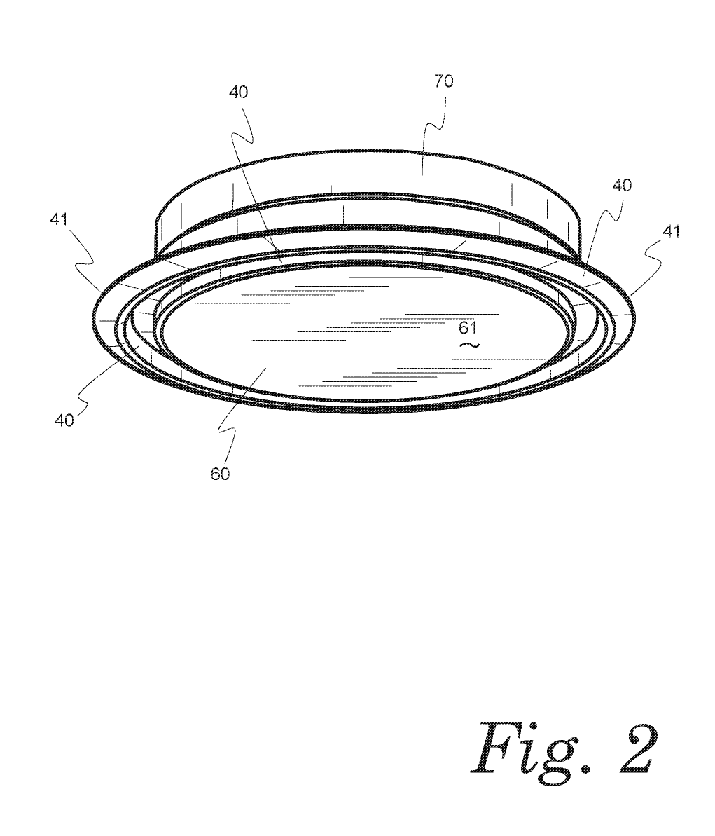

FIG. 2 illustrates a diffuser lens 60 and frame 40, together with a mount 70, according to an embodiment of the present invention. The diffuser lens 60 of the embodiment illustrated in FIG. 2 is shown to reside in a first plane 61. Frame 40 has a perimeter 41 and, in the embodiment illustrated in FIG. 2, is connected to a mount 70. In some embodiments of skylight 10, frame 40 and diffuser lens 60 may be connected to light shaft 30 with a mount 70, mount 70 itself connecting with light shaft 30.

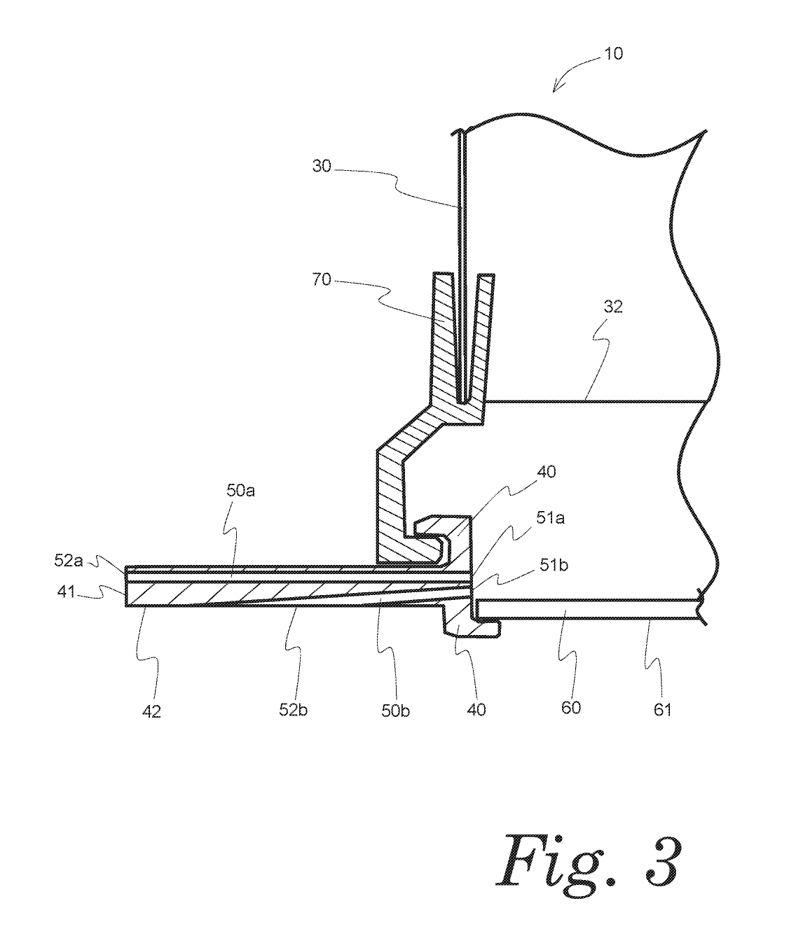

FIG. 3 is a sectional view of certain components of an embodiment of skylight 10. More specifically, FIG. 3 includes illustrations of embodiments of light shaft 30, frame 40, diffuser lens 60, and mount 70.

Further illustrated in the embodiment of FIG. 3 is first plane 61 of diffuser lens 60 and second plane 42 of frame 40; first plane 61 is parallel to second plane 42 in the illustrated embodiment.

In the embodiment illustrated in FIG. 3, light shaft 30 is connected to mount 70 at fourth end 32 of light shaft 30. In turn, mount 70 is connected to frame 40. Frame 40 includes two exemplary light paths 50 within frame 40, specifically light path 50a and light path 50b. Both light paths 50a, 50b may be included in a frame 40, or either may be included singly. Light path 50a includes a first end 51a disposed at light shaft 30 and a second end 52a disposed distal to light shaft 30, at perimeter 41 of frame 40. Light path 50b includes a first end 51b disposed at light shaft 30 and a second end 52b disposed distal to light shaft 30, along second plane 42 of frame 40. Light paths 50a, 50b are conductive of light, from light shaft 30 to second end 52a, 52b respectively. Light paths 50a, 50b may be voids or open pathways within frame 40. Alternatively, light paths 50a, 50b may comprise light conductive material, such as transparent or translucent glass, plastic, polymer, and the like, and blends thereof. Thus, light from light shaft 30 is transported by light path 50a, 50b to second end 52a, 52b respectively, as light path 50a, 50b extend from light shaft 30 toward perimeter 41, and would be visible to an occupant of the interior of a building in which frame 40 is disposed.

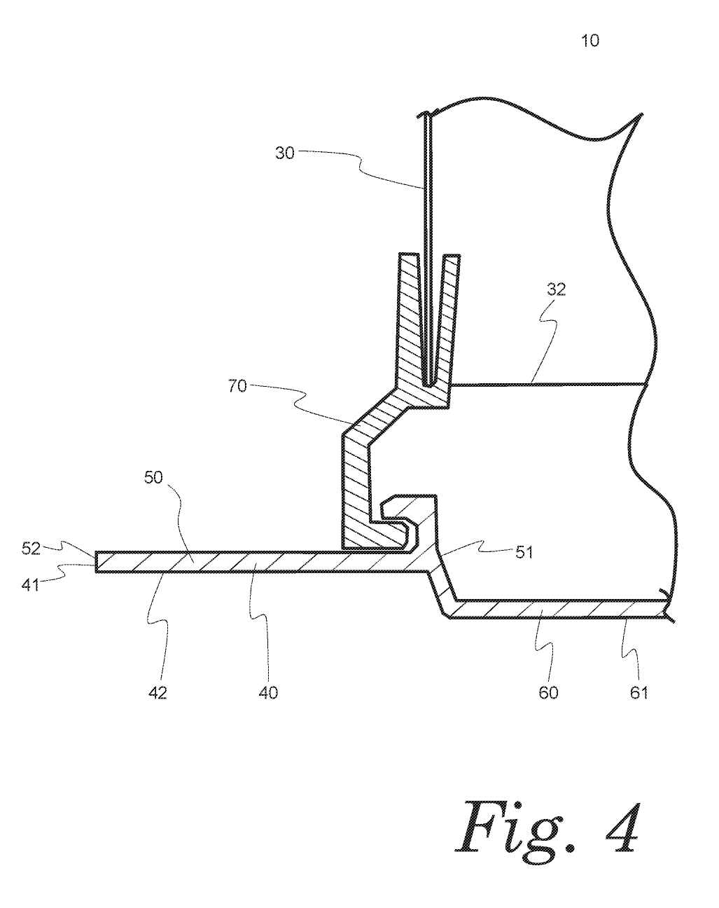

FIG. 4 is a sectional view of certain components of another embodiment of skylight 10, including illustrations of embodiments of light shaft 30, frame 40, diffuser lens 60, and mount 70. In the embodiment of FIG. 4, frame 40 itself is light conductive, and can be fabricated from glass, polymer, plastic, or combinations thereof. Thus, frame 40 is light transmissive from light shaft 30 to perimeter 41 and defines a light path 50 from light shaft 30 to perimeter 41. Accordingly, light from light shaft 30 is conveyed by light path 50 from light shaft 30 to perimeter 41, and would be visible to an occupant of the interior of a building in which frame 40 is disposed. With reference to FIG. 4, light within skylight 10 at fourth end 32 would impinge upon first end 51; because frame 40 itself is light conductive, that light is conveyed from first end 51 to, and exits at perimeter 41 from, second end 52, and thereby is visible to an occupant of the interior of a building in which frame 40 is located.

In some embodiments of the present invention, for example that illustrated by FIG. 4, the perimeter 41, which has received light from frame 40 acting as a light path 50, is exposed free of opacity about the entirety of the perimeter 41. Thus, light from the light shaft 30 may be observed at all points about the perimeter 41. In other embodiments, however, light may be blocked or occluded at select locations about perimeter 41, for decorative or other aesthetic purposes.

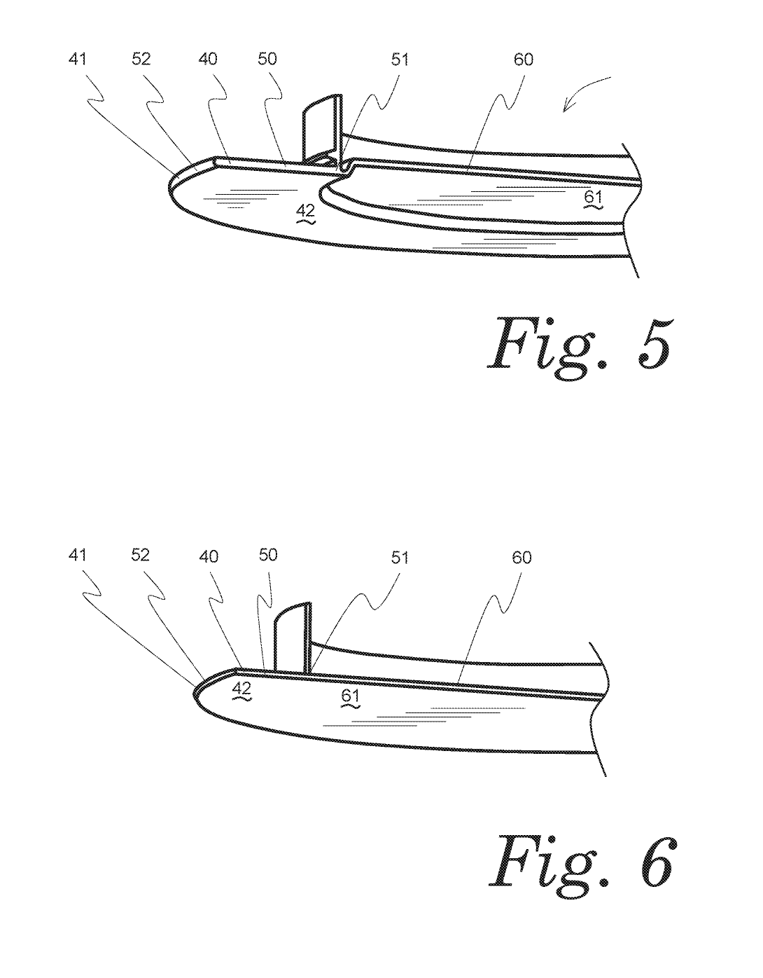

In the embodiments illustrated in FIGS. 3 and 4, first plane 61 of diffuser lens 60 resides below second plane 42 of frame 40. Alternative embodiments are illustrated in FIGS. 5 and 6. In the embodiment of FIG. 5, first plane 61 resides above second plane 42. In the embodiment of FIG. 6, first plane 61 and second plane 42 reside in the same plane. In the embodiments of FIGS. 5 and 6, frame 40 is light transmissive from light shaft 30 to perimeter 41 and may define a light path 50 from light shaft 30 to perimeter 41. Accordingly, light from light shaft 30 is transported by light path 50 from light shaft 30 to perimeter 41. It will be observed that the embodiments illustrated in FIGS. 5 and 6 provide a frame 40 that is integral with a diffuser lens 60.

It should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim requires more features than are expressly recited in that claim. Moreover, any components, features, or steps illustrated and/or described in a particular embodiment herein can be applied to or used with any other embodiment(s). Thus, it is intended that the scope of the inventions herein disclosed should not be limited by the particular embodiments described above, but should be determined only by a fair reading of the claims that follow.

The purpose of the Abstract is to enable the various Patent Offices and the public generally, and especially the scientists, engineers, and practitioners in the art who are not familiar with patent or legal terms or phraseology, to determine quickly from a cursory inspection the nature and essence of the technical disclosures of the application. The Abstract is not intended to be limiting as the scope of the invention in any way.

1. A skylight, comprising:
a light shaft;
a frame, the frame including a light path;
the light path having a first end and an opposite second end, the first end disposed proximate to the light shaft and the second end disposed distal to the light shaft, and the light path being light conductive from the light shaft to the second end.

2. The skylight of claim 1, in which the light shaft has a third end and an opposite fourth end, and the interior frame resides at the fourth end.

3. The skylight of claim 1, in which the frame defines the light path.

4. The skylight of claim 1, further including a diffuser lens.

5. The skylight of claim 1, further including a diffuser lens, wherein the diffuser lens is integral with the frame.

6. The skylight of claim 1, wherein the frame defines a perimeter and the second end is disposed at the perimeter.

7. A skylight, comprising:
a light shaft;
a frame, the frame having an outer perimeter disposed away from the light shaft;
a light path extending from the light shaft toward the outer perimeter and being light transmissive.

8. The skylight of claim 7, in which the light shaft has a first end and a second end, and the frame is disposed at the second end.

9. The skylight of claim 7, further including a diffuser lens, wherein the diffuser lens is carried by the frame.

10. The skylight of claim 7, further including a diffuser lens, the diffuser lens being integral with the frame.

11. The skylight of claim 7, wherein the light path extends to the outer perimeter.

12. The skylight of claim 7, further including a diffuser lens, the diffuser lens being integral with the frame, and wherein the light path extends to the outer perimeter.

13. The skylight of claim 7, wherein the light path extends to the outer perimeter and is exposed free of opacity about the perimeter.

14. The skylight of claim 7, further including a diffuser lens, the diffuser lens at least partially residing in a first plane, and the frame resides at least partially in a second plane, and the first plane is parallel to the second plane.

15. A skylight, comprising;
a light shaft, the light shaft having a first end and an opposite second end;
an interior diffuser lens, the interior diffuser lens residing at the second end;
a frame, the frame:
surrounding the interior diffuser lens;
being integral with the interior diffuser lens;
defining a perimeter distal to the light shaft; and
being light transmissive from the light shaft to the perimeter.

16. The skylight of claim 15, wherein the diffuser lens resides at least partially in a first plane and the frame resides at least partially in a second plane, the first plane being parallel to the second plane.

17. The skylight of claim 15, wherein the diffuser lens resides at least partially in a third plane and the frame resides at least partially in the third plane.

18. The skylight of claim 15, wherein the frame is exposed about the entirety of the perimeter.

19. The skylight of claim 15, further including a mount, the mount being connected to the light shaft and connected to the frame.

20. The skylight of claim 15, wherein the frame is annular.
